(19) United States
(12) Patent Application Publication
(10) Pub. No.: US 2008/0263936 A1
(43) Pub. Date: Oct. 30, 2008

(54) BIODEGRADABLE FISHING LURE AND MANUFACTURING METHODS

(76) Inventor: YUAN CHIEH SU, Huatan (TW)

Correspondence Address: TURNER PADGET GRAHAM & LANEY, P.A., P.O. BOX 1509, GREENVILLE, SC, 29602, US

(21) Appl. No.: 11/740,345

(22) Filed: Apr. 26, 2007

(51) Int. Cl. A01K 85/00

(52) U.S. Cl. 43/42.53; 43/42

(57) ABSTRACT

A fishing lure is composed of polyvinyl alcohol in combination with urea, agar or both to be highly performing and biodegradeable without requiring a freeze/thaw cycle.

### BACKGROUND OF THE DISCLOSURE

Polyhydroxy polymers such as polyvinyl alcohol (PVA) are used in the production of biodegradable fishing lures. The use of PVA in the composition of lures has so far required that a large proportion of the lures be made of water to allow the PVA to dissolve appropriately. Unfortunately, due to the presence of large volumes of water in the composition of currently available commercial PVA-containing fishing lures, the materials produced are too soft and sticky to set and shape easily. Therefore, these conventional lures do not offer complex shapes, detailed designs or widely varied colors.

Freeze/thaw cycles have been attempted to enhance the strength of PVA-containing fishing lures. Nevertheless, their shapes remain easily changed whilst in their package as a result of compression or squeezing. Furthermore, after absorption of water, the color of PVA will turn from transparent to white. Thus, on the whole, currently available biodegradable fishing lures do not compare favorably with existing polyvinyl chloride (PVC)-based fishing lures. This means recreational fishermen concerned with conservation and protection of the environment find it hard to switch from their highly performing PVC lures to biodegradable lures.

### BRIEF SUMMARY OF THE DISCLOSURE

The present disclosure is directed in general to biodegradable, recreational fishing lures and to their composition and manufacturing processes. The components and materials of the fishing lures are simple to manufacture and use.

As will be described in greater detail below, a PVA-based biodegradable material is provided for the production of recreational fishing lures as an alternative to conventional PVC fishing lures. In general, urea and only relatively small amounts of water are utilized in the biodegradable, recreational fishing lures. The presence of urea in the fishing lures facilitates solubility of PVA.

More particularly, urea facilitates dissolution of all ingredients at about 135° C. Unlike other PVA-containing fishing lures, more significant amounts of PVA can be added to the composition of the material in order to increase the strength of the lures and permit the production of lure shapes with thinner details. The reduced incorporation of water also means that the unaltered color of the material is transparent enough to allow the production of a wide range of colored lures after addition of pigments.

The manufacturing process according to the disclosure does not involve submitting the products to freeze/thaw cycles. The lures made with the compositions described herein are hard after ejection from the mold of the injection machine. The lures are then placed inside a water bath to allow absorption of water, fish attractants and the like, as well as expansion to final size.

Pure PVA has a Shore durometer reading of approximately 80 on an ASTM D2240 C type scale. Agar is added to the composition of the material to soften the lures and retain water within PVA thanks to its high water absorption capacity. Agar and PVA will bond together in solution and strengthen the lures. This means that the addition of agar to a PVA mixture allows the increase of the structural strength of the lures by permitting the use of more PVA in the composition of the material, without increasing the hardness of the final products.

Fishing lures according to aspects of the present disclosure are biodegradable, flexible, mainly transparent, soft, with a Shore reading between 12 and 30 on an ASTM D2240 C type scale. Their surface is non-sticky and complex designs and a wide range of colors can be produced.

As introduced above, fishing lures according to aspects of the present disclosure are biodegradable. All ingredients are safe to humans and animals, and the lures will not release harmful substances during biodegradation.

Production of the lures does not involve the use of freeze/thaw cycles, which have so far been important to PVA-based recreational fishing lures production. The various ingredients are loaded in a mixing machine and are mixed to produce small spheres of the material. An appropriate amount of spheres is then transferred to the injection machine. After heating, the material is injected into steel molds and takes the shape of the cavity in the mold. The resulting products are fishing lures made from a single piece of biodegradable material. The lures are hard when they are ejected from the mold. Then follows an expansion stage where the lures are soaked inside a water bath. Scents and/or fish attractants can be added to the water bath, so that they will be incorporated into the lures. As the material has a high capillarity, it will expand through the absorption of water until the lure reaches its full size. Thus, the size of cavity in the mold for the injection stage takes account of the later expansion of the material. As this process does not require a freezing stage, it remains low cost, energy efficient and environment friendly.

As opposed to currently available PVA-containing recreational fishing lures, a lure according to the present disclosure is mainly transparent. This allows the production of a wider range of colored lures, including mainly transparent. This is important for the performance of the lures, as both appropriate shape and color play a role in the creation of successful prey-like lures.

Flexibility of the material used in the lures is 30% to 60% better than that of currently commercially available PVA lures. Thanks to a greater flexibility, the swimming figure of the lures is more life-like.

Moreover, the ability to adjust the hardness of lures is important to the control of the swimming figure, which contributes to the lure displaying life-like characteristics and in due course increases potential strikes. The present disclosure permits production of lures with a variety of hardness ranging from a Shore reading of 12 to 30 on an ASTM D2240 C type scale. In addition, using the production process described herein, lures can be produced with different inner and outer body part hardness, consequently increasing the quality of the swimming figure. For example, if the lures are produced with harder inner and softer outer body parts, they will feel smooth on the outside but from on the inside. The firm inner body will keep the lure stable inside the water, whilst its softer outer body, such as legs and fins, will allow it to follow the movement of the waves, just as if it was alive.

The PVA utilized in this disclosure is a biodegradable, non-toxic, environment-friendly, hydrolyzed polymer. As its melting point is very close to its breaking down temperature, it is difficult to inject and mold. In addition, the biodegradation rate of this synthetic compound is very slow. However, both of these problems can be solved by mixing PVA with various other compounds, such as urea, agar, monopropylene glycol and the like and combinations of these.

Urea helps PVA to dissolve fully and thus facilitates the production of the material described herein. The addition of urea to PVA has another benefit, as it will be washed away from the final products in a running water bath. Indeed, as explained previously, the lures once ejected from the molds—after injection is completed—are hard and need to be soaked in a running-water bath that will allow the lures to expand to their final size. The material while in the bath absorbs a set volume of water. The cavities of the mold used to shape the material into lures must be designed whilst taking account of the final expansion of the products. To produce a finished product with fine detail would mean that an even finer detailed cavity would have to be created, causing some limitations to the designs. If the material injected inside the cavity contains a compound that will be washed away in the final bath and replaced by water, this means that the material will not expand as much but will still absorb the same volume of water. With the addition of urea, the size of the cavity in the mold can be enlarged by 60%, without affecting the final size of the lures, thus reducing the difficulties faced with finer detailed designs.

Agar is a seaweed extract and can be used to increase the biodegradable rate of PVA and also help PVA keep water from evaporating.

Monopropylene glycol (MPG) is used as a plasticizer. It helps keep the products from freezing at very low temperatures. Moreover, by adjusting its percentage in the composition of the material described herein, the hardness of the lures can be lowered.

Although PVA can be soaked in water and expanded, it does not absorb much water and still remains relatively hard. Although not normally an optimum material to produce fishing lures, by increasing its water absorption capacity, PVA is made into an excellent material for such a purpose. The following two approaches are offered:
modifying PVA molecule structure and reducing hydrolyzation; or
adding to PVA other biodegradable compounds, with increased water absorption capacity.

Mainly, the biodegradation rate of PVA is linked to its degree of polymerization (DP). The lower the DP, the easier the biodegradation. However, a low DP will automatically decrease its strength. Thus, a DP between 1,700 and 2,400 is offered as an appropriate balance between degradation rate and strength.

In a particular aspect of the disclosure, a biodegradable fish lure composition may have a quantity of water-soluble long-chain polyhydroxy polymer of polyvinyl alcohol with a molecular weight of less than about 105,600 and a degree of polymerization of at least about 1,700 and less than 2,400; a quantity of urea in an amount of the composition of about 10.0 to about 55.0% (w/w), the urea being configured to assist in dissolving the polyvinyl alcohol; a quantity of water in an amount of the composition of about from about 7.0% to about 35.0% (w/w) of the composition; and a quantity of agar in an amount of the composition of about 0.0 to about 4.0% (w/w) of the composition, the agar being configured to increase a biodegradable rate of the polyvinyl alcohol and to prevent water from evaporating from the polyvinyl alcohol, wherein the composition, being hard after molding, requires no freeze/thaw cycle.

In this aspect, the biodegradeable fish lure composition of the polyvinyl alcohol may be from about 12.0% to about 45.0% (w/w) of the composition.

Further in this aspect, the biodegradeable fish lure composition of the polyvinyl alcohol may include a degree of hydrolyzation from about 98.5% to about 99.2%.

Also in this aspect, the biodegradeable fish lure composition of the degree of polymerization may be about 1,700.

Further in this aspect, the biodegradeable fish lure composition may have a Shore hardness reading of about 12 to about 30.

Also in this aspect, the biodegradeable fish lure composition may be configured to block only about 30% of light.

Further in this aspect, the biodegradeable fish lure composition may further include a pigment.

Also in this aspect, the biodegradable fish lure composition may further include a fish attractant.

Further in this aspect, the biodegradable fish lure composition may further include a quantity of plasticizer.

Also in this aspect, the biodegradable fish lure composition wherein the plasticizer may be monopropylene glycol in an amount of the composition of about 0.0% to about 25.0% (w/w) of the composition.

Further in this aspect, the biodegradable fish lure composition may further include a quantity of gelatin, the gelatin being configured to increase a biodegradation rate of the composition.

The gelatin may include an amount of the composition of about 0.0% to about 50.0% (w/w) of the composition.

Further in this aspect, the biodegradable fish lure composition may further include a quantity of silicon dioxide, the silicon dioxide being configured to increase a weight of the composition and delay internal temperature changes thereof when the composition is disposed in an injection machine.

Also in this aspect, the biodegradable fish lure composition, wherein the silicon dioxide may be an animal protein in an amount of the composition of about 0.0% to about 10.0% (w/w) of the composition.

Further in this aspect, the biodegradable fish lure composition may further include a quantity of glycerin, the glycerin being used a solvent.

The glycerin may be about 0.0% to about 16.0% (w/w) of the composition.

In another aspect of the disclosure, a fish lure, may include a blend of about 12 wt % to about 45 wt % of polyvinyl alcohol having a molecular weight of less than about 105,600 and a degree of polymerization of about 1700; about 10.0 wt % to about 55.0 wt % of urea, the urea being configured to assist in dissolving the polyvinyl alcohol; about 7.0 wt % to about 35.0 wt % of water; and about 0.0% to about 4.0% of agar, the agar being configured to increase a biodegradable rate of the polyvinyl alcohol and to prevent the water from evaporating from the polyvinyl alcohol, wherein the fish lure is biodegradable, can release a fish attractant, and has a Shore 00 durometer reading of from about 12 to about 30.

Also in this aspect, the polyvinyl alcohol may be 98.5% to about 99.2% hydrolyzed.

Further in this aspect, the blend is not subjected to a freeze/thaw cycle after formation of the fish lure.

Also in this aspect, additives may include a plasticizer, the fish attractant, a quantity of silicon dioxide, a quantity of glycerin, a quantity of gelatin, a pigment and combinations thereof.

In a further aspect of this disclosure, a method of producing a biodegradable fishing lure may include a balanced hardness and flexibility characteristic, loading in a mixing apparatus about 12 wt % to about 45 wt % of polyvinyl alcohol having a molecular weight of less than about 105,600 and a degree of polymerization of about 1700 to about 2400; loading in the mixing apparatus components selected from the group consisting of urea, agar and combinations thereof, the urea being about 10.0 wt % to about 55.0 wt % and the agar being about 0.0 wt % to about 4.0 wt %; mixing the polyvinyl alcohol with the urea or the agar or both the urea and the agar to produce a substantially clear resin; loading the resin in an injection machine; loading the resin in a mold; and forming a biodegradable fishing lure without use of a freeze/thaw cycle.

The method may also include adding about 0.0 wt % to about 16.0 wt % of glycerin as a solvent.

The method may also include adding in the mixing apparatus about 7.0 wt % to about 35.0 wt % of water.

The method may also include adding about 0.0 wt % to about 10.0 wt % of gelatin to increase a biodegradation rate of the fishing lure.

The method may also include adding about 0.0 wt % to about 50.0 wt % of silicon dioxide to increase a weight of the fishing lure.

The method may also include soaking the fishing lure in a water bath to expand to the fishing lure size.

The method may also include soaking the fishing lure in a water bath to remove the urea.

The method may also include adding a plasticizer of about 0.0 wt % to about 25.0 wt %.

The method may also include adding a pigment to color the fishing lure.

The method may also include adding a fish attractant.

The method may also include soaking the fishing lure in a water bath to absorb a fish attractant or to expand in size.

Other advantages of various embodiments of the disclosure will be apparent from the following description and the attached drawings, or can be learned through practice of the disclosure.

### BRIEF DESCRIPTION OF THE DRAWINGS

A full and enabling disclosure, including the best mode thereof to one skilled in the art, is set forth more particularly in the remainder of the specification, including reference to the accompanying figures, in which:

FIG. 1 is a side elevational view of a fishing lure according to an aspect of the disclosure;

FIG. 2 is a sectional view of the fishing lure taken along line II-II in FIG. 1; and

FIG. 3 is a schematic view of an exemplary manufacturing process line for a fishing lure as in FIG. 1 according to yet another aspect of the disclosure.

### DETAILED DESCRIPTION OF THE DISCLOSURE

Detailed reference will now be made to the drawings in which examples of the present disclosure are shown. The detailed description uses numerical and letter designations to refer to features of the drawings. Like or similar designations of the drawings and description have been used to refer to like or similar parts of the disclosure.

The drawings and detailed description provide a full and written description of examples of the disclosure, and of the manner and process of making and using these examples, so as to enable one skilled in the pertinent art to make and use them, as well as the best mode of carrying out the disclosure. The examples set forth in the drawings and detailed description are provided by way of explanation only and are not meant as limitations of the disclosure. The present disclosure thus includes any modifications and variations of the following examples as come within the scope of the appended claims and their equivalents.

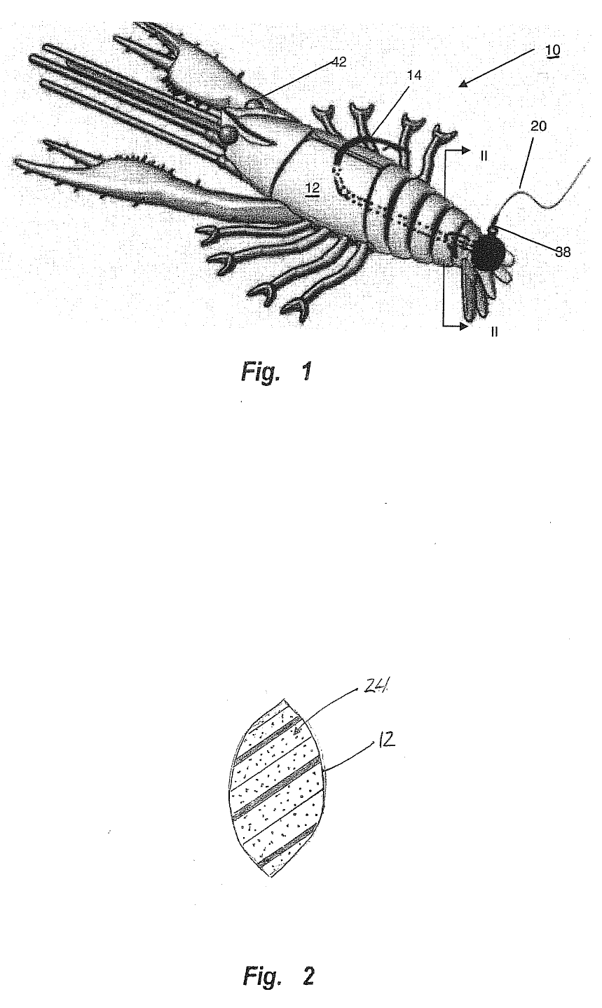

With reference now to FIG. 1, according to an aspect of the present disclosure, a fishing lure is designated in general by the element number 10 and includes a body 12. As shown, the body 12 may include a fishhook 14 punctured into the lure 10. In this example, the hook 14 is inserted in the body 12 from a tail end of the body 12 and exits the body 12 at the level of a head end of the body 12. As shown, a fishing line 20 of a fishing rod or rig (not shown) may be attached to the hook 14 by the hookring 38. The skilled artisan will appreciate that if a jighead hook was inserted in the illustrated position, the lure 10 could be used for bass fishing. Moreover, the hook 14 may be inserted in different parts of the body 12 for different kinds of fish, and a person skilled in the art of fishing would be able to determine how to insert the hook 14.

FIG. 1 further shows that the body 12 may include one or more scales, fins, eyes and other natural features 42 to simulate appearance and swimming action of a small fish or other bait. Those skilled in the fishing art will instantly recognize and appreciate that the shape of the body 12 and the features 42 can be altered in various ways to simulate many types of bait fish or other sea life or insects and the like and the disclosure is not limited to the example shown in FIG. 1.

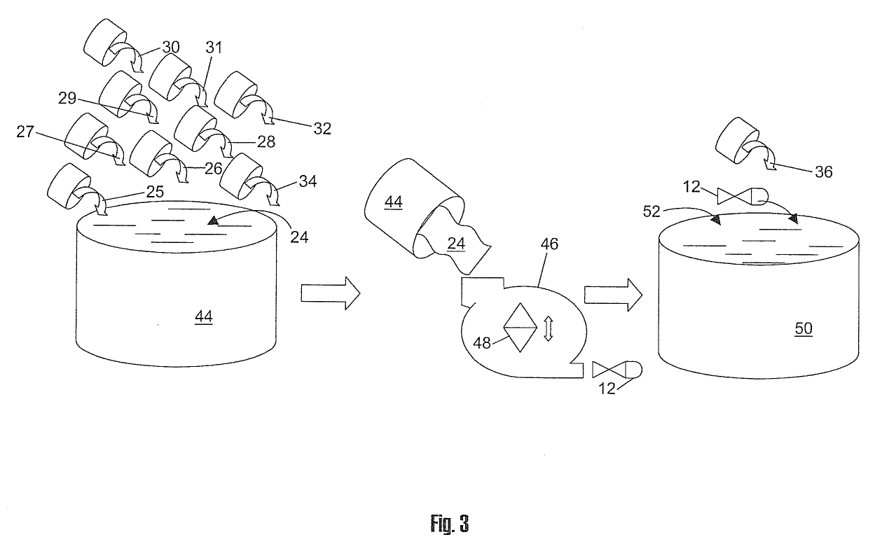

Turning now to FIG. 2, a cross section of the body 12 most clearly shows that the body 12 is formed of a resin 24 (also referred to herein as a mixture, a material or a composition). Polyhydroxy polymers of the composition 24 are selected amongst different PVA with a molecular weight of less than about 105,600, a degree of polymerization of about 1,700, and a degree of hydrolyzation ranging from about 98.5 to about 99.2%. The amount of PVA 25 is from about 12.0 to about 45.0% weight to weight (%(w/w)) of the total composition 24, i.e., the material injected in one or more molds 48 as described in greater detail below with respect to FIG. 3.

Referring now to both FIGS. 2 and 3, glycerin 26 may be used as a solvent. The glycerin 26 may be added to cool the material 24 ejected from the mold 48 more quickly. In this case, the material 24 will be shaped quickly in the mold 48 and will be easily removed from the mold 48. The glycerin 26 represents from about 0.0 to about 16.0% (w/w) total composition of the material 24.

An amount of water 27 present in the mixture 24 represents from about 7.0 to about 35.0% (w/w) of the total composition 24. Apart from the water 27 included in the composition 24 at the time of injection, a further volume of water 52 may be added to the final products 12 during a water bath stage 50 as shown in FIG. 3.

A gelatin 28 may also be used according to the disclosure. The gelatin 28 may be an animal protein that can increase the biodegradation rate of the material 24. The gelatin 28 represents from about 0.0 to about 10.0% (w/w) of the total composition 24.

Also shown in FIG. 3, silicon dioxide 29 may be used, which is harmless to humans and animals. Silicon dioxide 29 can increase the relative weight of the material 24 and delay internal temperature changes of the material 24 in an injection machine 46. The amount of silicon dioxide 29 is from about 0.0 to about 50.0% (w/w) of the total composition 24.

FIG. 3 also shows that urea 30 may be used to fully dissolve the PVA 25 at a temperature of about 135 degrees Celsius without the need for a large volume of water. The amount of urea 30 is from about 10.0 to about 55.0 % (w/w) of the total composition 24. However, after the lures 10 are soaked in the water bath 50 to expand to their full size, the urea 30 will be removed from the final products 12 by the running water 52.

FIG. 3 further shows that monopropylene glycol (MPG) 31 may be used as a plasticizer. MPG 31 represents from about 0.0 to about 25.0 % (w/w) of the total composition 24.

Agar 32 may also be used to soften the fishing lures 10 and to prevent water from evaporating out of their material 24. Agar 32 represents from about 0.0 to about 4.0% (w/w) of the total composition 24.

The reduced incorporation of water 27 as described above also means that the material 24 is sufficiently transparent to allow addition of pigments 34, which provides for a wide range of colored lures.

FIG. 3 also shows that a fishing attractant or scent 36 may be added at the stage of the water bath 50 to be incorporated into the lures 12 when they expand by absorption of the water 52. Exemplary fish attractants may be hydrolyzed anise solubles, hydrolyzed abalone solubles, hydrolyzed tuna solubles, hydrolyzed shrimp solubles, hydrolyzed oyster solubles, hydrolyzed crab solubles, hydrolyzed lobster solubles, hydrolyzed pork solubles, hydrolyzed beef solubles, and the like. The scent attractant 36 will be released gradually when the lures 12 are used and placed in a pond, lake or river.

The disclosure may be better understood with reference to the following examples and to the figures.

### EXAMPLE 1

A composition, such as material 24 above, of following formulation was prepared:

| Component | Amount (% (w/w)) |
|---|---|
| PVA (25) (98.5–99.2% hydrolyzed, | 25.5 |
| with a DP of 1,700) | |
| Water (27) | 10.2 |
| Urea (30) | 45.9 |
| MPG (31) | 17.9 |
| Agar (32) | 0.5 |

Manufacturing process: the various ingredients were loaded in a mixing apparatus or machine 44, heated to 110 degrees Celsius and mixed to produce small spheres of the material 24. The spheres were then added to the injection machine 46 and heated to 135 degrees Celsius to melt completely and injected into a steel mold 48 to take the shape of the cavity in the mold 48. The resulting products are fishing lures 12 made from a single piece of biodegradable material 24. The lures 12 at this stage are hard when ejected from the mold 48. Then follows an expansion stage in which the lures 12 are soaked in the water bath 50. Scent 36 may be added to the water bath 50 at the time the lures 12 are soaked so that the scent 36 will be incorporated into the lures 12. The material 24 has a high capillary action and will expand by absorbing water 52 until the lure 12 reaches its full size. Thus, the size of cavity in the mold 48 takes into account the later expansion of the lures 12.

In this example, the formulation was molded into 48 mm long grub-shaped lures 12. The lures 12 each weighed 2.000 g dry. The lures 12 were then placed into the water bath 50 at 22 degrees Celsius for 5 hours, after which they individually weighed 2.600 g. Immediately after this first bath, the lures 12 were transferred to a second bath at 40 degrees Celsius, and left to soak for 2 hours, reaching a final individual weight of 3.000 g. The lures 12 had a final Shore reading of 12 on an ASTM D2240 C type scale. The lures 12 were left to dry, and their dry weight was recorded at 1.077 g, individually. The final product thus contained 1.923 g of water, 64.1% (w/w) of the composition of the lure 12. The difference between the increase in water content and the actual weight increase of the lures 12 is due to the partial loss of some of the ingredients, including urea 30 and MPG 31 washed away in the water bath 50. These losses amounted to 0.923 g per lure 12.

### EXAMPLE 2

Alterations to the composition of the material make it possible to control the hardness of the finished product. Accordingly, lures 12 with the following formulations were prepared:

| | Amount (% (w/w)) | |
|---|---|---|
| Component | Formulation A | Formulation B |
| PVA (25) (98.5–99.2% hydrolyzed, | 25.5 | 37.0 |
| with a DP of 1,700) | | |
| Water (27) | 10.2 | 22.2 |
| Urea (30) | 45.9 | 25.9 |
| MPG (31) | 17.9 | 0.0 |
| Agar (32) | 0.5 | 0.0 |
| Glycerin (26) | 0.0 | 14.9 |

Manufacturing procedure: formulations of the above compositions were prepared and followed the same manufacturing procedure as Example 1.

Lures 12 made from formulation A had a Shore reading of 12 on an ASTM D2240 C type scale, whilst lures 12 made from formulation B had a reading of 30.

### EXAMPLE 3

Compositions of the following formulations, with or without agar 32, were prepared to evaluate the benefit of using agar 32 in the production of the lures 12:

| | Amount (% (w/w)) | |
|---|---|---|
| Component | Formulation A | Formulation B |
| PVA (25) (98.5–99.2% hydrolyzed), | 20.7 | 20.5 |
| with a DP of 1,700 | | |
| Water (27) | 12.4 | 12.3 |
| Urea (30) | 31.1 | 30.8 |
| MPG (31) | 14.5 | 14.4 |
| Agar (32) | 0.0 | 0.9 |
| Gelatin(28) | 0.6 | 0.6 |
| Silicon dioxide (29) | 20.7 | 20.5 |

Manufacturing procedure: formulations of the above compositions were prepared and followed the same manufacturing procedure as Example 1, but were molded in the shape of stick worms, which were 135 mm long. The head section was 10 mm in diameter, the body 12 mm and the tail 8 mm. The lures 12 reached this full size after being placed inside the water bath 50 at 25 degrees Celsius for 8 hours.

Method of testing: immediately after production, the individual weights of the lures 12 were recorded. The lures 12 were then left to dry out on a table in a room with 70% humidity, and their weight recorded at regular intervals. The results of the test are presented below (average of 3 samples):

| Days | Formulation A | Formulation B |
|---|---|---|
| 0 | 10.9 | 10.9 |
| 1 | 7.7 | 8.1 |
| 2 | 7.0 | 7.4 |
| 5 | 3.9 | 4.0 |
| 10 | 3.7 | 3.9 |

The presence of agar 32 in formulation A delayed the loss of water by evaporation from the lures 12. This is of particular interest for the continued use of the lure 12 taken out of its protective packaging.

### EXAMPLE 4

Tensile strength and elongation were tested following the method described below. A composition of the following formulation was prepared:

| Component | Amount (% (w/w)) |
|---|---|
| PVA (25) (98.5–99.2% hydrolyzed), | 17.5 |
| with a DP of 1,700 | |
| Water (27) | 10.5 |
| Urea (30) | 31.7 |
| MPG (31) | 10.5 |
| Agar (32) | 1.4 |
| Gelatin(28) | 2.1 |
| Silicon dioxide (29) | 26.3 |

Manufacturing procedure: formulations of the above compositions were prepared and followed the same manufacturing procedure as Example 1, but were molded in the shape of worms, which were 100 mm in length and 8 mm in diameter. The lures 12 reached their full size after being placed inside the water bath 50 at 25 degrees Celsius for 8 hours.

Method of testing: Gamarktsu (worm 300) number 1 hooks were inserted into the lures 12, 5 mm from each extremity of the lure. The hooks were then attached to the grips of an Instron 5569 universal material testing machine, to record the tensile strength and elongation before break. The grips were separated at a rate of 50 mm per min. The rate of elongation and the tensile strength were read at their highest before the lure 12 broke. The test was carried out for the worms of the composition described above, as well as commercially available PVA-based biodegradable recreational lures and commercially available PVC-based recreational lures, of similar shape and size. The results of the test are presented below (average of 3 samples):

| | Tensile strength | Elongation |
|---|---|---|
| | (N) | (%) |
| Commercial PVC-based lures | 4.452 | +63.6 |
| Commercial PVA-based lures | 5.403 | +40.1 |
| Lures of the composition described above | 7.188 | +82.5 |

The lures 12 made out of the material described herein proved to be more resistant to tensile stress than other commercially available biodegradable lures and PVC lures. Yet, the lures 12 could also be stretched a lot more than either of these two other types of materials. The combination of these two qualities makes more resistant, flexible lures for more life-like behavior in the water.

### EXAMPLE 5

Compositions of the following formulations, with or without MPG, were prepared to evaluate the benefit of using agar MPG the production of lures:

| | Amount (% (w/w)) | |
|---|---|---|
| Component | Formulation A | Formulation B |
| PVA (25) (98.5–99.2% hydrolyzed), | 21.4 | 18.6 |
| with a DP of 1,700 | | |
| Water (27) | 12.8 | 11.2 |
| Urea (30) | 42.8 | 37.4 |
| MPG (31) | 0.0 | 13.0 |
| Agar (32) | 0.9 | 0.7 |
| Gelatin(28) | 0.7 | 0.5 |
| Silicon dioxide (29) | 21.4 | 18.6 |

Manufacturing procedure formulations of the above compositions were prepared and followed the same manufacturing procedure as Example 1, but were molded in the shape of frogs, which were 80 mm in length. The lures 12 were 64 mm wide at the body section, and 80 mm wide at the rear leg section. The maximum thickness was 13 mm at the body section. The lures 12 reached their full size after being placed inside the water bath 50 at 25 degrees Celsius for 8 hours.

Method of testing: immediately after production, the individual hardness of the lures 12 was recorded at the thickest part of the body, on an ASTM D2240 C type scale. The lures 12 were then placed in a freezer at minus 12 degrees Celsius, and their hardness read at regular intervals. The results of the test are presented below (average of 3 samples):

| Time (h) | Formulation A | Formulation B |
|---|---|---|
| 0 | 16 | 16 |
| 0.5 | 29 | 23 |
| 1 | 66 | 29 |
| 2 | 95 | 39 |
| 5 | 95 | 39 |
| 12 | 95 | 39 |
| 24 | 95 | 40 |

The presence of MPG 31 in the lures 12 delayed the freezing of the lures 12 as testified by the delayed increased in hardness caused by the exposure of the material 24 to a freezing temperature. This is of particular benefit for the use of recreational fishing lures in colder climates.

### EXAMPLE 6

The transparency of a material used for the production of recreational fishing lures is of importance to achieve a life-like appearance of the lures and improve the chance of obtaining a bite from fish. The following test shows that the material 24 described here is mostly transparent, thus allowing for a wide range of colored lures to be produced. Compositions of the following formulation were prepared:

| Component | Amount (% (w/w)) |
|---|---|
| PVA (25) (98.5–99.2% hydrolyzed), | 22.8 |
| with a DP of 1,700 | |
| Water (27) | 13.6 |
| Urea (30) | 45.5 |
| MPG (31) | 13.6 |
| Agar (32) | 1.8 |
| Gelatin(28) | 2.7 |

Method of testing a block of material, 50mm long, 50 mm wide, and 4 mm thick was produced following the same manufacturing procedure as Example 1. The full size was reached after placing the block inside a water bath at 25 degrees Celsius for 8 hours. This material was then submitted to a yellowness index difference, after a weathering resistance test, using a Hunter-Lab Color Quest XE luminous transmittance meter following ASTM D1746-03 standard. The test was carried out at an ambient temperature of 23 degrees Celsius and 50% relative humidity. In this test, samples showed an average transmittance of 69.89%, with wavelengths of 540-560 mm, which fell within the visible radiations range for the human eye. This result indicates a high degree of transparency for the material, as it blocked only 30% of the light going through.

### EXAMPLE 7

The relative weight of the lures can be controlled by addition of more or less silicon dioxide in the composition of the material. Thus, the following formulations were prepared to show how silicon dioxide 29 might affect the final product 12:

| | Amount (% (w/w)) | | |
|---|---|---|---|
| | Formulation | Formulation | Formulation |
| Component | A | B | C |
| PVA (25) (98.5–99.2% | 18.7 | 15.8 | 13.6 |
| hydrolyzed, with a | | | |
| DP of 1,700 | | | |
| Water (27) | 11.2 | 9.5 | 8.2 |
| Urea (30) | 37.5 | 31.5 | 27.2 |
| MPG (31) | 13.1 | 11.0 | 9.5 |
| Agar (32) | 0.4 | 0.3 | 0.3 |
| Gelatin (28) | 0.4 | 0.3 | 0.3 |
| Silicon dioxide (29) | 18.7 | 31.5 | 40.8 |

Manufacturing procedure: formulations of the above compositions were prepared and followed the same manufacturing procedure as Example 1, but were molded in the shape of stick worms, which were 135 mm in length. The lures 12 were 6 mm in diameter at the head section, 10 mm at the body section, and 4 mm at the tail section. The lures 12 reached their full size after being placed inside the water bath 50 at 25 degrees Celsius for 8 hours.

Method of testing: immediately after production, the individual weights of the lures 12 were recorded. The results of the test are presented below (average of 3 samples):

| Formulation | Weight (g) |
|---|---|
| A | 6.9 |
| B | 7.5 |
| C | 8.5 |

### EXAMPLE 8

Resistance to variations in ambient temperature is important for long-term storage and transport of recreational fishing lures. The following test shows that slight modifications to the composition of the material allow for improved resistance to high temperatures, without the need to produce lures with a high degree of hardness. Method of testing: the following formulations were prepared:

| | Amount (% (w/w)) | |
|---|---|---|
| Component | Formulation A | Formulation B |
| PVA (25) (98.5–99.2% hydrolyzed), | 18.7 | 19.7 |
| with a DP of 1,700 | | |
| Water (27) | 11.2 | 15.8 |
| Urea (30) | 37.5 | 39.5 |
| MPG (31) | 13.1 | 4.0 |
| Agar (32) | 0.4 | 0.8 |
| Gelatin (28) | 0.4 | 0.4 |
| Silicon dioxide (29) | 18.7 | 19.8 |

The preparation followed the same manufacturing procedure as Example 5. Immediately after production, the individual hardness of each of the lures 12 was recorded at the thickest part of the body on an ASTM D2240 C type scale. The lures 12 were then placed in an oven at 50, 55 or 60 degrees Celsius, and their hardness read at regular intervals. The results of the test are presented below (average of 3 samples):

| | Formulation A | | | Formulation B | | |
|---|---|---|---|---|---|---|
| | at | at | | at | at | |
| Time (H) | 50° C. | 55° C. | at 60° C. | 50° C. | 55° C. | at 60° C. |
| 0 | 16 | 16 | 16 | 21 | 21 | 21 |
| 0.5 | 12 | 10 | 2 | 21 | 19 | 14 |
| 1 | 10 | 5 | 0 | 20 | 18 | 12 |
| 2 | 5 | 0 | 0 | 19 | 17 | 12 |
| 5 | 5 | 0 | 0 | 19 | 17 | 12 |

The lures 12 made from formulation B, with an initial Shore C reading of 21, remained relatively unaffected by long-term exposure to temperatures of 50 degrees Celsius and short-term exposure to temperatures of up to 60 degrees Celsius.

### EXAMPLE 9

The rate of release of additive from lures 12 was tested to assess the ability of the material to release fish attractants 36 in water.

Method of testing: stick worms, weighing 7.6 g individually, were produced as described in Example 3, with formulation B. A food-grade, green-colored additive was added to the water 52 used for expansion of the lures 12 in the water bath 50. The lures 12 were left to soak for 8 hours in the water bath 50 at a temperature of 25 degrees Celsius. At the end of the bath stage 50, the lures 12 had become green. The lures 12 were then placed 10 at a time in a clear glass container or beaker filled with 0.5 liter of water each, at room temperature. The test was carried out in triplicate. The coloration of the water in the containers was then monitored.

Results of the test: after only 8, 8 and 10 min, water from each of the 3 beakers containing the lures 12 with colored additive, had started to turn green, as detected with a naked eye.

The material 24 described here can thus easily absorb additives by simple capillarity, and release the additives quickly when returned to water. This quality is key to releasing efficiently fish attractants that will increase the lure desirability for fishes. The ability to add to additives and fish attractants post-production of the raw material (i.e. during the expansion stage in water) simplifies the production of fishing lures, as taking account of the attractants in the composition of the raw material (and modifying it accordingly), as well as in the limitations to production, is not necessary.

While preferred embodiments have been shown and described, those skilled in the art will recognize that other changes and modifications may be made to the foregoing examples without departing from the scope and spirit of the disclosure. It is intended to claim all such changes and modifications as fall within the scope of the appended claims and their equivalents.

That which is claimed is:

1. A biodegradable fish lure composition, comprising:
a quantity of water-soluble long-chain polyhydroxy polymer of polyvinyl alcohol with a molecular weight of less than about 105,600 and a degree of polymerization of at least about 1,700 and less than 2,400;
a quantity of urea in an amount of the composition of about 10.0 to about 55.0% (w/w), the urea being configured to assist in dissolving the polyvinyl alcohol;
a quantity of water in an amount of the composition of about from about 7.0% to about 35.0% (w/w) of the composition; and
a quantity of agar in an amount of the composition of about 0.0 to about 4.0% (w/w) of the composition, the agar being configured to increase a biodegradable rate of the polyvinyl alcohol and to prevent water from evaporating from the polyvinyl alcohol, wherein the composition, being hard after molding, requires no freeze/thaw cycle.

2. The biodegradeable fish lure composition as in claim 1, wherein the polyvinyl alcohol is from about 12.0% to about 45.0% (w/w) of the composition.

3. The biodegradeable fish lure composition as in claim 1, wherein the polyvinyl alcohol includes a degree of hydrolyzation from about 98.5% to about 99.2%.

4. The biodegradeable fish lure composition as in claim 1, wherein the degree of polymerization is about 1,700.

5. The biodegradeable fish lure composition as in claim 1, wherein the composition has a Shore hardness reading of about 12 to about 30.

6. The biodegradeable fish lure composition as in claim 1, wherein the composition is configured to block only about 30% of light.

7. The biodegradeable fish lure composition as in claim 1, further comprising a pigment.

8. The biodegradable fish lure composition as in claim 1, further comprising a fish attractant.

9. The biodegradable fish lure composition as in claim 1, further comprising a quantity of plasticizer.

10. The biodegradable fish lure composition as in claim 9, wherein the plasticizer is monopropylene glycol in an amount of the composition of about 0.0% to about 25.0% (w/w) of the composition.

11. The biodegradable fish lure composition as in claim 1, further comprising a quantity of gelatin, the gelatin being configured to increase a biodegradation rate of the composition.

12. The biodegradable fish lure composition as in claim 11, wherein the gelatin is in an amount of the composition of about 0.0% to about 50.0% (w/w) of the composition.

13. The biodegradable fish lure composition as in claim 1, further comprising a quantity of silicon dioxide, the silicon dioxide being configured to increase a weight of the composition and delay internal temperature changes thereof when the composition is disposed in an injection machine.

14. The biodegradable fish lure composition as in claim 1, wherein the silicon dioxide is an animal protein in an amount of the composition of about 0.0% to about 10.0 % (w/w) of the composition.

15. The biodegradable fish lure composition as in claim 1, further comprising a quantity of glycerin, the glycerin being used a solvent.

16. The biodegradable fish lure composition as in claim 15, wherein the glycerin is about 0.0% to about 16.0% (w/w) of the composition.

17. A fish lure, comprising a blend of:
about 12 wt % to about 45 wt % of polyvinyl alcohol having a molecular weight of less than about 105,600 and a degree of polymerization of about 1700;
about 10.0 wt % to about 55.0 wt % of urea, the urea being configured to assist in dissolving the polyvinyl alcohol;
about 7.0 wt % to about 35.0 wt % of water; and
about 0.0% to about 4.0% of agar, the agar being configured to increase a biodegradable rate of the polyvinyl alcohol and to prevent the water from evaporating from the polyvinyl alcohol, wherein the fish lure is biodegradable, can release a fish attractant, and has a Shore 00 durometer reading of from about 12 to about 30.

18. The fish lure as in claim 17, wherein the polyvinyl alcohol is 98.5% to about 99.2% hydrolyzed.

19. The fish lure as in claim 17, wherein the blend has not been subjected to a freeze/thaw cycle after formation of the fish lure.

20. The fish lure as in claim 17, further comprising additives selected from the group consisting of a plasticizer, the fish attractant, a quantity of silicon dioxide, a quantity of glycerin, a quantity of gelatin, a pigment and combinations thereof.

21. A method of producing a biodegradable fishing lure having a balanced hardness and flexibility characteristic, the method comprising:
loading in a mixing apparatus about 12 wt % to about 45 wt % of polyvinyl alcohol having a molecular weight of less than about 105,600 and a degree of polymerization of about 1700 to about 2400;
loading in the mixing apparatus components selected from the group consisting of urea, agar and combinations thereof, the urea being about 10.0 wt % to about 55.0 wt % and the agar being about 0.0 wt % to about 4.0 wt %;
mixing the polyvinyl alcohol with the urea or the agar or both the urea and the agar to produce a substantially clear resin;
loading the resin in an injection machine;
loading the resin in a mold; and
forming a biodegradable fishing lure without use of a freeze/thaw cycle.

22. The method as in claim 21, further comprising adding about 0.0 wt % to about 16.0 wt % of glycerin as a solvent.

23. The method as in claim 21, further comprising adding in the mixing apparatus about 7.0 wt % to about 35.0 wt % of water.

24. The method as in claim 21, further comprising adding about 0.0 wt % to about 10.0 wt % of gelatin to increase a biodegradation rate of the fishing lure.

25. The method as in claim 21, further comprising adding about 0.0 wt % to about 50.0 wt % of silicon dioxide to increase a weight of the fishing lure.

26. The method as in claim 21, further comprising soaking the fishing lure in a water bath to expand to the fishing lure size.

27. The method as in claim 21, further comprising soaking the fishing lure in a water bath to remove the urea.

28. The method as in claim 21, further comprising adding a plasticizer of about 0.0 wt % to about 25.0 wt %.

29. The method as in claim 21, further comprising adding a pigment to color the fishing lure.

30. The method as in claim 21, further comprising adding a fish attractant.

31. The method as in claim 21, further comprising soaking the fishing lure in a water bath to absorb a fish attractant or to expand in size.

32. A biodegradable fish lure composition, consisting essentially of:
a quantity of water-soluble long-chain polyhydroxy polymer of polyvinyl alcohol with a molecular weight of less than about 105,600 and a degree of polymerization of at least about 1,700 and less than 2,400;
a quantity of urea in an amount of the composition of about 10.0 to about 55.0% (w/w), the urea being configured to assist in dissolving the polyvinyl alcohol;
a quantity of water in an amount of the composition of about from about 7.0% to about 35.0% (w/w) of the composition; and
a quantity of agar in an amount of the composition of about 0.0 to about 4.0% (w/w) of the composition, the agar being configured to increase a biodegradable rate of the polyvinyl alcohol and to prevent water from evaporating from the polyvinyl alcohol, wherein the composition, being hard after molding, requires no freeze/thaw cycle.

33. The biodegradeable fish lure composition as in claim 32, wherein the polyvinyl alcohol is from about 12.0% to about 45.0% (w/w) of the composition.

34. The biodegradeable fish lure composition as in claim 32, wherein the polyvinyl alcohol includes a degree of hydrolyzation from about 98.5% to about 99.2%.

35. The biodegradeable fish lure composition as in claim 32, wherein the degree of polymerization is about 1,700.
